(19) United States
(12) Patent Application Publication
(10) Pub. No.: US 2022/0259887 A1
(43) Pub. Date: Aug. 18, 2022

(54) WIRE FENCE CLIP FOR PIPE POST

(71) Applicant: Vernon L. Miller, Fredericksburg, OH (US)

(72) Inventors: VERNON L. MILLER, Fredericksburg, OH (US); Sylvan A. Yoder, Holmesville, OH (US)

(73) Assignee: Vernon L. Miller

(21) Appl. No.: 17/178,446

(22) Filed: Feb. 18, 2021

(51) Int. Cl. E04H 17/10; E04H 17/04; E04H 17/26

(52) U.S. Cl. CPC E04H 17/124; E04H 17/261; E04H 17/04

(57) ABSTRACT

An apparatus and method for securing fence wire to posts employs a fence clip having a ring-like body with first and second legs extending from the body on opposite sides of an opening within the body. A nut and bolt arrangement is employed for drawing the legs toward each other, reducing the opening and clamping the ring-like body about a cylindrical post. Each of the fence clips also has a pair of containment guides extending from opposite edges of the ring-like body, the containment guides forming a passageway for receiving and maintaining barbed wire. The openings of the passageway are flared outwardly to accommodate the entry of the barbed wire into the passageway regardless of the direction in which the barbed wire passes. The fence clips are adjustable, repositionable, and reusable.

### TECHNICAL FIELD

The invention herein resides in the art of fencing apparatus and devices. More particularly, the invention relates to a wire fence clip for pipe posts and, most particularly, to wire fence clips for pipe posts adapted for receiving and maintaining barbed wire.

### BACKGROUND OF THE INVENTION

It is commonly known to use an arrangement of wire and posts to secure an area for the confinement of animals, such as livestock and the like. Quite often, barbed wire is employed for retaining livestock, such as cattle and goats. In many applications, barbed wire is strung between wooden posts and is attached to the posts as by fence staples and the like. In many applications, the posts are not wooden, but are of cylindrical tubular steel construction received by media such as earth, concrete, or the like.

Since steel posts are not given to utilization of fencing staples, other means for securing the barbed wire to the posts are necessary. In the past, it has been known to either tack weld the wire directly to the post itself, or to weld or otherwise fixedly secure a wire fence clip to the post, with the clip serving to receive and maintain the barbed wire in the fencing arrangement. Such prior art devices and techniques, however, are not given to ease of removal, reuse, or repositioning. Moreover, the prior art clips were not easy to use during fence construction and did not readily accept insertion of the barbed wire or accommodate its movement within the clips to replace the barbed wire within the clips or remove it therefrom.

There is a need in the art for a wire fence clip for metal pipe posts that overcomes the deficiencies of the prior art and accommodates ease of use including installation, positioning, repositioning, removal and the like.

### SUMMARY OF THE INVENTION

In light of the foregoing, it is a first aspect of the invention to provide a wire fence clip for pipe posts that is easily and readily positionally engageable with a metal-type post.

Another aspect of the invention is the provision of a wire fence clip for pipe posts that is easily secured to and removable from a metal pipe post.

A further aspect of the invention is the provision of a wire fence clip for a metal pipe post that is easily adjustable upon the post itself

Still a further aspect of the invention is the provision of a wire fence clip for pipe posts that provides a travel path or passageway for barbed wire passing through the clip and for retaining the barbed wire within that travel path.

Yet a further aspect of the invention is the provision of a wire fence clip for pipe posts in which the travel path is flared at both ends of the travel path, the flared openings being provided to accommodate the insertion and removal of the barbed wire.

Yet another aspect of the invention is the provision of a wire fence clip for pipe posts that is not permanently attached to the pipe posts, but is easily and readily removable therefrom and re-attachable thereto.

Still a further aspect of the invention is the provision of a wire fence clip for pipe posts that is given to ease of manufacture and implementation in constructing barbed wire fences, while accommodating the adjustability of such fences and the reuse of the clips themselves.

The foregoing and other aspects of the invention that will become apparent as the detailed description proceeds are achieved by a clip for securing fence wire to a post, comprising a ring-like body; first and second legs extending from said body on opposite sides of an opening within said body; means for drawing said legs toward each other, reducing said opening and a diameter of said ring-like body; and first and second containment guides extending from said ring-like body and establishing a passageway for receiving and containing wire.

Additional aspects of the invention are achieved by a barbed wire fence system, comprising a plurality of posts, each said post having a fence clip mounted thereto; a string of barbed wire passing through fence clips of sequentially positioned posts; and wherein each said fence clip is mounted to its associated post in a releasable, repositionable, and reusable manner and comprises a ring-like body with first and second containment guides extending from opposite edges thereof, said containment guides being circumferentially offset from each other to establish a passageway therebetween for slidingly receiving and maintaining said string of barbed wire.

Yet further aspects of the invention are achieved by a method for building, maintaining and reestablishing a barbed wire fence, comprising setting a plurality of posts in spaced relation about a perimeter of an area to be enclosed by the fence; mounting fence clips on said post in desired positioning relationship with each other; drawing barbed wire sequentially through a passageway of each of said fence clips of adjacent posts, said passageways each having ends to accommodate barbs of said barbed wire; and securing ends of said barbed wire to complete the fence.

### DESCRIPTION OF DRAWINGS

For an appreciation of the various aspects of structure, functions and implementations of the invention, reference should be had to the following detailed description and accompanying drawings, wherein:

FIG. 1 is an illustrative view of a portion of a barbed wire fence employing metal fence posts and the fence clips of the invention;

FIG. 2 is a top plan view of the barbed wire fence clip for metal pipe posts made in accordance with the invention; and

FIG. 3 is a side elevational view of the fence clip of FIG. 2.

### DETAILED DESCRIPTION OF PREFERRED EMBODIMENTS

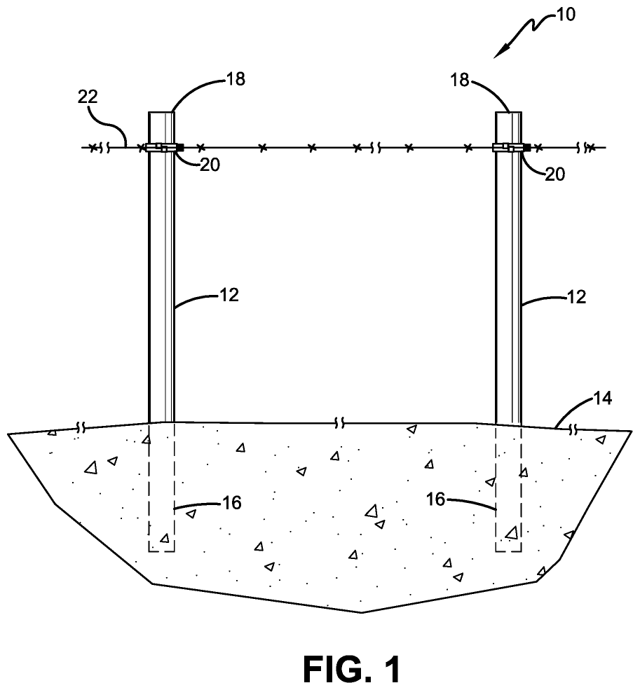

With reference now to FIG. 1, it can be seen that a barbed wire fence system made in accordance with the instant invention is designated generally by the numeral 10. The fence system 10 consists of a plurality of cylindrical or tubular posts 12 of wood, metal or other appropriate material. According to a preferred embodiment of the invention, the posts 12 are of galvanized steel. The posts 12 are received by the ground or other supporting structure or media 14. A bottom portion 16 of the post 12 may be subterranean when the supporting surface 14 is ground or earth, or it may be received by braces or brackets when the support structure 14 is a hard surface such as concrete, asphalt or the like.

The post 14 may be capped at an upper end 18, or may simply remain open.

In accordance with the invention, positionally adjustable, removable and replaceable fence clips 20, also preferably of galvanized steel construction, are maintained by and about the cylindrical or tubular posts 12, and as presented below, are uniquely designed and configured to receive and maintain strands of barbed wire 22.

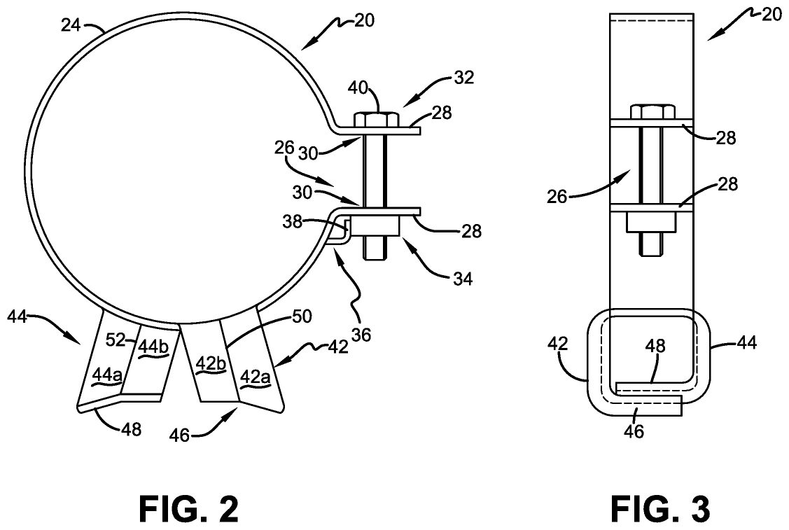

With reference now to FIGS. 2 and 3, an appreciation can be obtained with regard to the particular structure of the fence clips 20 of the invention. As shown, the fence clips 20 have a circular body 24 having a diameter to accommodate the diameter of the post 12. The body 24 has an opening 26 between outwardly extending flanges or legs 28 having aligned holes 30 for receiving machine bolts 32 or other appropriate fastener. A nut 34, such as a square nut, threadingly receives the machine bolt 32. A side of the nut 34 is in contacting engagement with an inwardly turned end 38 of a tab 36 that is connected to the outer surface of the fence clip 20. The inwardly turned end 38 engages the nut 34 to prevent rotation of the nut 34 as the bolt head 40 is tightened, bringing the flanges 28 toward each other in tightening engagement of the inner circumference of the body 24 of the fence clip 20 about the outer circumference of the post 12. This accommodates ease of engagement and disengagement of the fence clip 20 with the associated post 12. The invention also contemplates that the tab 36 may be formed as a 90° downward bend of the adjacent leg 28.

A containment guide 42 extends from a first edge of the circular body 24 of the fence clip 20, and a second containment guide 44 extends from an opposite second edge thereof. The containment guides 42, 44 have respective flanges 46, 48 extending inwardly, generally toward each other, a distance of 70-90% of the width of the circumference of the body 24 of the fence clip 20. The flanges 46, 48 may be flared outwardly about respective radially extending lines 50, 52 thus separating the containment guide 42 into sections 42a and 42b, and the containment guide 44 into separating portions 44a , 44b . The containment guides 42, 44 and associated flanges 46, 48 flare outwardly about the flare line 50, 52 to provide a passage for barbed wire 22 passing in either direction therebetween. The containment guides and flanges provide a passageway for the barbed wire that is flared outwardly at both ends to assist in guiding the barbed wire as it passes in either direction through the passage between the outer circumference of the circular body 24 the interior sides of the containment guides 42, 44, and the flanges 46, 48. This flared passage accommodates movement of barbed wire, without the barbs hanging up on the elements 42, 48 because of their outwardly flared nature at the opposite ends of the passageway.

It will be appreciated that the dimensions and configuration of the fence clip 20 are dependent primarily upon the size of the post 12 with which they are employed. According to a preferred embodiment of the invention, the circular body 24 has a diameter on the order of 2.875 inch and a width on the order of 0.75 inch. The containment guides 42, 44 preferably have a width on the order of 0.75 inch and a length on the order of 0.625 inch. The invention contemplates that these dimensions may change to accommodate various sizes of posts.

In use, the adjustable fence clips are placed over a post 12 and are clamped thereon by tightening of the machine bolt 32 and nut 34, drawing the flanges 28 toward each other. After mounting a desired number of fence clips 20 to associated posts 12, barbed wire may be strung between the clips by passing the barbed wire through the passageway defined between interior surfaces of the containment guides 42, 44 and the outward circumferential surface of the body 24. The inwardly extending flanges 46, 48 complete the passageway by providing an exterior wall opposite the interior wall provided by the body itself. The flared nature of the containment guide 42, 44 and flanges 46, 48 accommodate guided entrance into the passageway as the barbed wire passes thereinto and therefrom.

The terminal end of the barbed wire can be appropriately fixed to a final post in any of numerous ways.

Thus, it can be seen that the various aspects of the invention have been achieved by the structures and techniques presented and described above. While in accordance with the patent statutes, only the best known and preferred embodiment of the invention has been presented and described in detail, the invention is not limited thereto or thereby. Accordingly, for an appreciation of the true scope and breadth of the invention, reference should be made to the following claims.

What is claimed is:

1. A clip for securing fence wire to a post, comprising:
a ring-like body;
first and second legs extending from said body on opposite sides of an opening within said body;
means for drawing said legs toward each other, reducing said opening and a diameter of said ring-like body; and
first and second containment guides extending from said ring-like body and establishing a passage for receiving and containing wire.

2. The clip for securing fence wire according to claim 1, wherein said first and second containment guides extend radially from first and second edges of said ring-like body.

3. The clip for securing fence wire according to claim 2, wherein said first and second containment guides are circumferentially offset from each other, said offset establishing a length of said passage.

4. The clip for securing fence wire according to claim 3, wherein each said first and second containment guide has a flange at an end thereof, said flanges extending axially and providing an outer wall to said passage.

5. The clip for securing fence wire according to claim 4, wherein said flanges angle outwardly from said passage at opposite ends of said passage.

6. The clip for securing fence wire according to claim 5, wherein each said containment guide flares outwardly about a radially extending flare line.

7. The clip for securing fence wire according to claim 6, wherein said flanges angling outwardly and said containment guides flaring outwardly establish mouths to said passage.

8. The clip for securing fence wire according to claim 3, wherein said means for drawing said legs toward each other comprises a nut and bolt.

9. The clip for securing fence wire according to claim 8, wherein a tab extends from said body in contacting, rotation-inhibiting engagement with said nut.

10. The clip for securing fence wire according to claim 9, wherein said legs are circumferentially offset from said containment guide by 90 degrees.

11. A barbed wire fence system, comprising:
a plurality of posts, each said post having a fence clip mounted thereto;
a string of barbed wire passing through fence clips of sequentially positioned posts; and
wherein each said fence clip is mounted to its associated post in a releasable, repositionable, and reusable manner and comprises a ring-like body with first and second containment guides extending from opposite edges thereof, said containment guides being circumferentially offset from each other to establish a passageway therebetween for slidingly receiving and maintaining said string of barbed wire.

12. The barbed wire fence system as recited in claim 11, wherein each said containment guide has a flange at an end thereof, said flanges establishing boundaries to said passageway and defining an open mouth to said passageway.

13. The barbed wire fence system as recited in claim 12, wherein said fence clips further comprise an adjustable clamp for regulating an effective diameter of said ring-like body.

14. The barbed wire fence system as recited in claim 13, wherein said clamp comprises a nut and bolt interposed between a pair of legs extending opposite each other from an opening in said ring-like body.

15. A method for building, maintaining and reestablishing a barbed wire fence, comprising:
setting a plurality of posts in spaced relation about a perimeter of an area to be enclosed by the fence;
mounting fence clips on said post in desired positional relationship with each other;
drawing barbed wire sequentially through a passageway of each of said fence clips of adjacent posts, said passageways each having open ends to accommodate the barbs of said barbed wire; and
securing ends of said barbed wire to complete the fence.

16. The method for building, maintaining and reestablishing a barbed wire fence according to claim 15, further comprising the step of adjusting the fence by loosening one or more fence clips from associated posts and repositioning said fence clips upon said post.

17. The method for building, maintaining and reestablishing a barbed wire fence according to claim 15, further comprising:
withdrawing said barbed wire back through said fence clips;
removing said fence clips from their posts;
repositioning said fence clips on different posts about a perimeter of a different area;
drawing said barbed wire sequentially through the passageway of said fence clips of adjacent ones of said different posts; and
securing ends of said barbed wire to complete a new fence about a different area.

18. The method for building, maintaining and reestablishing a barbed wire fence according to claim 17, wherein said passageways are flared and tapered to accommodate passage of barbed wire through said passageway in either direction.
